(19) United States
(12) Patent Application Publication
(10) Pub. No.: US 2021/0293567 A1
(43) Pub. Date: Sep. 23, 2021

(54) System And Method To Identify Points Of Interest From Within Autonomous Vehicles

(71) Applicant: Huawei Technologies Co., Ltd., Shenzhen (CN)

(72) Inventors: Luis Bill, Plano, TX (US); Di Zhang, Plano, TX (US); Haoting Li, Plano, TX (US); Lei Yang, Plano, TX (US); Hai Yu, Plano, TX (US)

(21) Appl. No.: 17/338,383

(22) Filed: Jun. 3, 2021

Related U.S. Application Data
(63) Continuation of application No. PCT/US2019/040880, filed on Jul. 8, 2019.

(51) Int. Cl. G01C 21/36; G06N 3/02

(52) U.S. Cl. CPC G01C 21/3644; G06N 3/02; G01C 21/3608; G01C 21/3664

(57) ABSTRACT

The disclosure relates to technology within an autonomous vehicle for interacting with passengers to provide information about their surroundings as they travel within the autonomous vehicle. In one example, the system may automatically detect and push information about points of interest in the vicinity of the vehicle to the vehicle passengers. In another example, the system provides information about points of interest around the autonomous vehicle in response to physical and/or verbal cues from a passenger in the autonomous vehicle.

### CROSS-REFERENCE TO RELATED APPLICATIONS

This application is a continuation of International Application No. PCT/US2019/040880 filed on Jul. 8, 2019, by Futurewei Technologies, Inc., and titled “System And Method To Identify Points Of Interest From Within Autonomous Vehicles,” which is hereby incorporated by reference.

### TECHNICAL FIELD

The disclosure generally relates to vehicles, and in particular to a system in an autonomous vehicle that detects and responds to requests for information about points of interest around an autonomous vehicle.

### BACKGROUND

Self-driving vehicles, in which sensors and software replace human drivers in controlling, navigating, and driving the vehicle, will in the near future radically transform our transportation system. One of the major benefits of hands-free travel is that it provides a vast potential for the driver to interact in new ways with the interior and exterior of the vehicle environment. In light of this, it would be advantageous to provide a system that is able to understand and support such interaction. Autonomous vehicles further provide significant potential for the tourist industry, for example in the ability of self-guided vehicles to provide tours of landmarks and other areas. Self-guided vehicles will also provide enhanced autonomy and travel options for handicapped individuals and those otherwise not able to drive. Each of these scenarios would benefit from a system that is able to better understand and support new methodologies of user interaction with the vehicle.

### SUMMARY

In embodiments, there is provided a system within an autonomous vehicle capable of interacting with passengers to provide information about their surroundings as they travel within the autonomous vehicle. In one example, the system may automatically detect and push information about points of interest in the vicinity of the vehicle to the vehicle passengers. In another example, the system provides information about points of interest around the autonomous vehicle in response to physical and/or verbal cues from a passenger in the autonomous vehicle.

According to one aspect of the present disclosure, there is provided a system for identifying a point of interest around an autonomous vehicle, comprising: a set of one or more sensors within the autonomous vehicle for sensing data related to at least one of body pose, eye gaze, a pointing gesture and speech by a passenger in the autonomous vehicle; an output device within the autonomous vehicle; and a computer within the autonomous vehicle, the computer executing instructions to: receive an indication of a direction from data related to the passenger received from the set of one or more sensors, determine a point of interest lying in the direction of the received indication of direction, and cause the output device to output information related to the determined point of interest.

Optionally, in any of the preceding aspects, the data received from the set of one or more sensors relates to a position of the passenger's head and eyes.

Optionally, in any of the preceding aspects, the data received from the set of one or more sensors relates to a pointing gesture performed by the passenger.

Optionally, in any of the preceding aspects, the data received from the set of one or more sensors relates to recognized speech describing a direction at which the point of interest is located.

Optionally, in any of the preceding aspects, the computer determines the point of interest from the received indication of direction, and received data relating to stored locations of points of interest around the autonomous vehicle.

Optionally, in any of the preceding aspects, the received data relates to a topography around the autonomous vehicle comprises at least one of global positioning system (GPS) data, data sensed by a second set of one or more sensors on the autonomous vehicle and data received from a cloud service.

According to one aspect of the present disclosure, there is provided a system for identifying a point of interest around an autonomous vehicle, comprising: a set of one or more sensors within the autonomous vehicle for sensing data related to at least one of body pose, eye gaze, a pointing gesture and speech by a passenger in the autonomous vehicle; an output device within the autonomous vehicle; and a computer within the autonomous vehicle, the computer executing instructions to: infer a directional response vector from the data sensed by the set of one or more sensors, identify a point of interest around the autonomous vehicle which lies along the directional result vector, and cause the output device to output information relating to the point of interest.

Optionally, in any of the preceding aspects, the computer further identifies speech from the passenger, the computer using the recognized speech to assist in identifying the point of interest.

Optionally, in any of the preceding aspects, the computer further receives external information in order to identify the point of interest which lies along the directional result vector.

Optionally, in any of the preceding aspects, a body and gesture detection module is implemented by the computer, the body and gesture detection module detecting a skeletal model of the passenger at at least one instant in time.

Optionally, in any of the preceding aspects, a head vector module is implemented by the computer for determining a head vector from the skeletal model, the head vector indicating a direction the passenger's head is facing.

Optionally, in any of the preceding aspects, an eye gaze vector module is implemented by the computer for determining an eye gaze vector indicating a direction the passenger's eyes are looking.

Optionally, in any of the preceding aspects, a finger pointing vector module is implemented by the computer for determining a finger pointing vector from the skeletal model, the finger pointing vector indicating a direction along which the passenger's hand is pointing.

Optionally, in any of the preceding aspects, a speech recognition module is implemented by the computer for recognizing speech related to the identity of the point of interest.

Optionally, in any of the preceding aspects, a multimodal response interpretation module receives at least one of the head vector, eye gaze vector, finger pointing vector and recognized speech, and inferring the directional response vector from the received at least one of the head vector, eye gaze vector, finger pointing vector and recognized speech.

Optionally, in any of the preceding aspects, the multimodal response interpretation module is implemented using machine learning methods such as, but not limited to, a neural network.

According to another aspect of the present disclosure, there is provided a method of identifying a point of interest around an autonomous vehicle, comprising: receiving an indication of a direction from data received from a passenger of the autonomous vehicle related to at least one of body pose and speech recognition; determining a point of interest lying in the direction of the received indication of direction; outputting the determined point of interest to an output device within the autonomous vehicle.

Optionally, in any of the preceding aspects, the step of receiving an indication of a direction at which the point of interest is located comprises the step of receiving data relating to a position of the passenger's head and eyes.

Optionally, in any of the preceding aspects, the step of receiving an indication of a direction at which the point of interest is located comprises the step of receiving and recognizing a pointing gesture performed by the passenger.

Optionally, in any of the preceding aspects, the step of receiving an indication of a direction at which the point of interest is located comprises the step of receiving and recognizing speech from the passenger describing a direction at which the point of interest is located.

Optionally, in any of the preceding aspects, the step of determining the point of interest lying in the direction of the received indication of direction comprises the step of received data relating to stored points of interest around the autonomous vehicle.

According to a further aspect of the present disclosure, there is provided a non-transitory computer-readable medium storing computer instructions that when executed by one or more processors cause the one or more processors to perform the steps of: receiving an indication of a direction at which a point of interest is located from data received from a passenger of an autonomous vehicle related to at least one of body pose and speech recognition; determining a point of interest lying in the direction of the received indication of direction; outputting information related to the determined point of interest to an output device within the autonomous vehicle.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

Aspects of the present disclosure are illustrated by way of example and are not limited by the accompanying figures for which like references indicate elements.

FIG.1 is a schematic top view of a driving environment in which embodiments of the present technology may be implemented.

FIG. 2 is a schematic view of a network environment in which embodiments of the present technology may be implanted.

FIG. 3 is a perspective view of an exterior of an autonomous vehicle including a number of sensors for sensing the vehicle's interaction with this driving environment.

FIG. 4 is a side view of an interior of an autonomous vehicle including a number of sensors for sensing physical and/or auditory attributes of passengers within the vehicle.

FIG. 5 is a flowchart illustrating steps of an embodiment of the present technology where point of interest information is automatically pushed to passengers in an autonomous vehicle.

FIG. 6 is a perspective view of a driving environment including an autonomous vehicle and a point of interest.

FIG. 7 is a schematic representation of modules for implementing embodiments of the present technology.

FIG. 8 is a flowchart illustrating steps of an embodiment of the present technology where point of interest information is provided to passengers in an autonomous vehicle in response to physical and/or verbal cues requesting point of interest information.

FIG. 9 is an illustration of a verbal cue in which a passenger is asking for information on a point of interest around an autonomous vehicle.

FIG. 10 is an illustration of a physical cue relating to passenger head position and eye gaze which may be interpreted as the passenger asking for information on a point of interest around an autonomous vehicle.

FIG. 11 is an illustration of a physical cue relating to a pointing gesture by a passenger which may be interpreted as the passenger asking for information on a point of interest around an autonomous vehicle.

FIG. 12 is an illustration of a verbal cue in which a passenger is clarifying the requested information on a point of interest around an autonomous vehicle.

FIG. 13 is a schematic block diagram of an exemplary computing environment for implementing aspects of the present technology.

### DETAILED DESCRIPTION

The present disclosure will now be described with reference to the figures, which in general relate to a system within an autonomous vehicle capable of interacting with passengers to provide information about their surroundings as they travel within the autonomous vehicle. In one example, the system may operate in an automatic push mode, where information about points of interest in the vicinity of the vehicle is automatically detected and pushed to the vehicle passengers.

In a further example, the system detects physical and/or verbal cues from a passenger indicating a request for information regarding a point of interest viewed by the passenger while traveling in the autonomous vehicle. The point of interest can be any feature in the vehicle surroundings, including for example a feature of the landscape or any of a wide variety of man-made structures. The physical and/or verbal cues may come from any of multiple modes of passenger expression, including for example head and eye gaze looking at a point of interest, a finger pointing at the point of interest and/or speech referring to the point of interest.

The physical and verbal cues may be processed to determine where the passenger is looking or pointing. This determination may possibly be bolstered by other cues, including something said by the passenger. The present technology further accesses external data providing information on any points of interest in the determined direction and within a given vicinity of the vehicle. If a most likely point of interest is identified which lies in the direction indicated by the passenger, information relating to the point of interest is relayed to the passenger, for example visually on a heads up display and/or audibly on the automobile speakers.

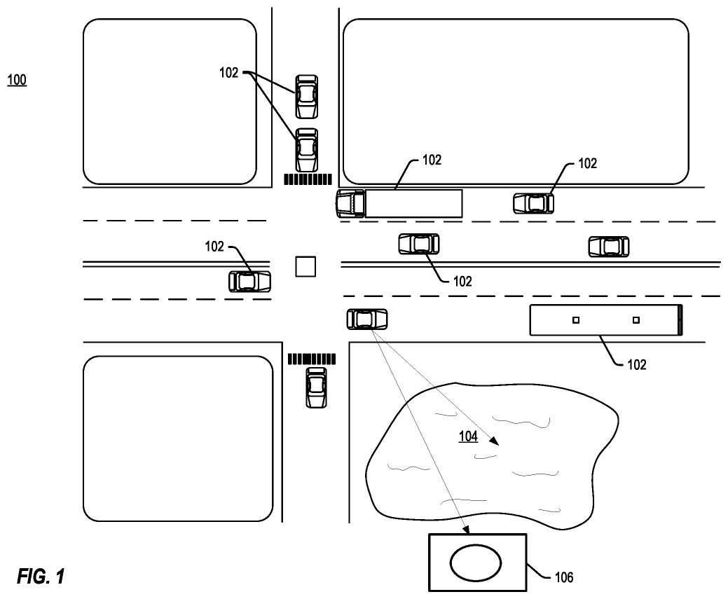

FIG. 1 is a top schematic view of a driving environment 100. The environment 100 shown is by way of example, and the present technology may be employed in any environment in which autonomous vehicles drive or may be driven. FIG. 1 shows a number of autonomous vehicles 102, which may include autonomous automobiles, trucks, buses, vans, and possibly other motorized vehicles. The respective positions, types and numbers of autonomous vehicles shown is by way of example only, and may vary in further embodiments. While the present technology is described below with reference to land-based autonomous vehicles, the principles of the present technology may also be applied to water-based autonomous vehicles such as boats and ships, or air-based autonomous vehicles such as planes, helicopters and flying cars.

In accordance with aspects of the present technology, an autonomous vehicle 102 may provide information to the one or more passengers within the vehicle about a point of interest (“POI”) within a given vicinity of the vehicle. A POI may be any of a wide variety of objects within the surroundings of the autonomous vehicle 102. The POI may for example be naturally occurring and/or part of the landscape, such as for example a pond 104. The POI may for example be a man-made structure, such as for example a building 106. However, it is understood that the POI described by the present technology may be any point of interest in the surroundings of vehicle 102 while stationary or while it is moving within the driving environment 100. Such POIs may be a fixed part of the surroundings of the autonomous vehicle 102, such as for example pond 104 or a building 106. Such POIs may alternatively be temporary, such as for example a traveling fair or street festival. The one or more passengers in the autonomous vehicle 102 may encounter a variety of different POIs as the autonomous vehicle travels within the driving environment 100.

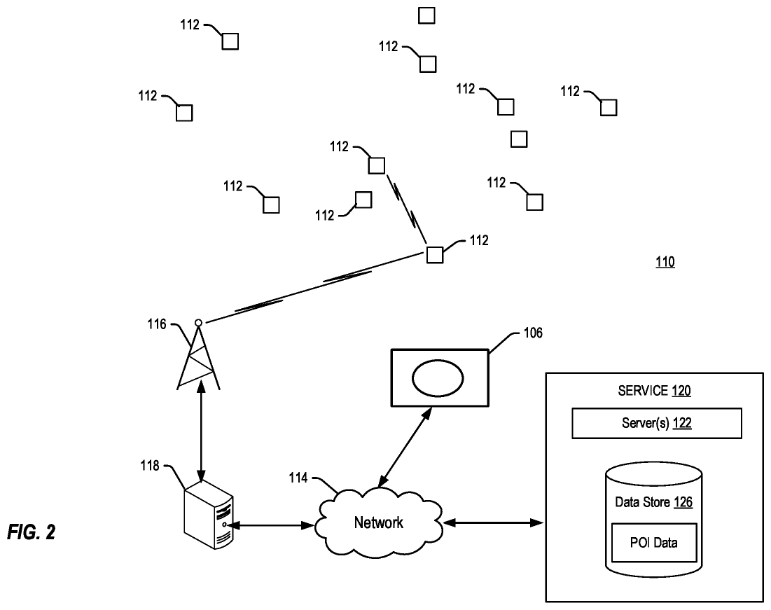

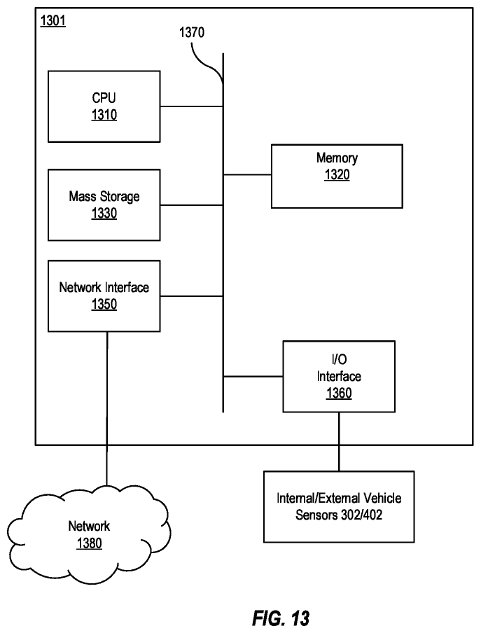

FIG. 2 is a schematic representation of a communications network 110 enabling a vehicle to access information regarding its driving environment. Each of the vehicles 102 may include an on-board computer 112, capable of discerning and providing information regarding POIs within the driving environment 100. On-board computer 112 of an autonomous vehicle 102 may for example be a computing system built into the autonomous vehicle 102, and may also be responsible for the autonomous driving functions of the vehicle 102. In further embodiments, the on-board computer 112 may be in communication with another computing system in vehicle 102 that is responsible for the autonomous driving functions of the vehicle 102. A sample implementation of the on-board computer is set forth below with respect to FIG. 13.

In embodiments, the on-board computer 112 in each autonomous vehicle 102 may be configured for peer-to-peer communications with the on-board computer 112 of each other vehicle 102 within a predefined distance of each other. Additionally, the on-board computer 112 of each autonomous vehicle 102 may be configured for wireless communication with a network 114 via wireless protocols and/or via a mobile telephone network. The mobile telephone network may include base stations 116 (one of which is shown) for transferring data and software between the autonomous vehicles 102 and a mobile network backbone 118. Backbone 118 may in turn have a network connection to network 114.

In accordance with aspects of the present technology, the on-board computer 112 of an autonomous vehicle 102 may obtain information regarding POIs from different sources. One of the sources may be a cloud service 120. Cloud service 120 may include one or more servers 122, including a webserver 106 connected to network 114, and a data store 126 for storing information regarding POIs and other data.

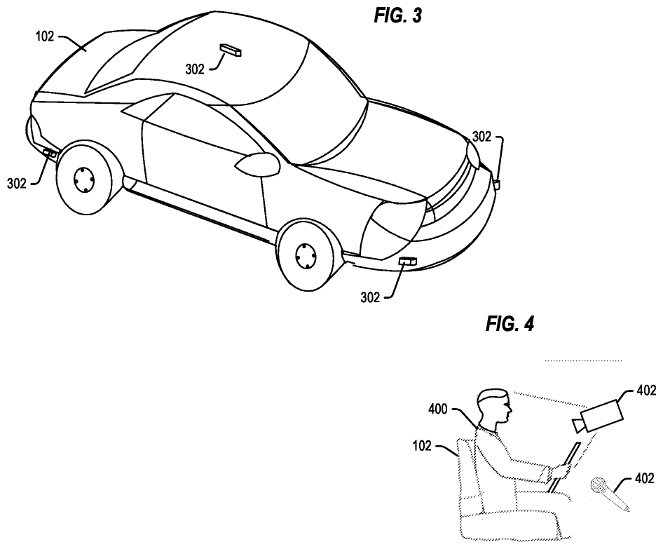

FIG. 3 shows an example of an autonomous vehicle 102 including various sensors 302 for gathering data about its environment including other autonomous vehicles and POIs. These sensors 302 may include but are not limited to one or more color cameras, near-infrared (NIR) cameras, time-of-flight cameras, or any other camera or imaging sensor available and suitable for the system. The system may also utilize various other sensors, such as light detection and ranging (Lidar), depth sensors, radars, sound sensors, ultrasonic sensors, among other sensors that can be suitable for object detection. The autonomous vehicles 102 may also include GPS receivers for detecting its position relative to the positions of POIs in its vicinity. The particular sensors 302 shown in FIG. 3 are by way of example only, and the autonomous vehicle 102 may include other sensors in other locations in further embodiments.

FIG. 4 shows an example of an interior of an autonomous vehicle 102, such, including various sensors 402 for gathering data about one or more passengers within the autonomous vehicle for use as explained below. These sensors 402 may include but are not limited to one or more color, NIR, time-of-flight or other cameras, and/or other sensors, such as depth, sound, or other sensors suitable for passenger detection. The particular sensors 402 shown are by way of example only, and the interior of the autonomous vehicle 102 may include other sensors in other locations in further embodiments.

In one embodiment, the present technology may operate in an automatic POI push mode, where POIs are automatically detected around a stationary or moving autonomous vehicle 102, and information relating to those POIs is automatically pushed to the vehicle 102. The automatic POI push mode may be beneficially used in a wide variety of scenarios. For example, a passenger in an autonomous vehicle 102 may wish to be informed of, and gain information on, POIs as his or her autonomous vehicle travels within a driving environment.

It may also happen that a passenger is visually impaired, or that the windows of an autonomous vehicle 102 are darkened or otherwise made opaque, such as for example when the vehicle 102 is in a sleep or privacy mode. In this instance, a passenger may receive information regarding POIs and vehicle progress without seeing his or her driving environment. An automatic POI push mode may also be advantageously used in autonomous tourist vehicles to point out POIs to tourists within the vehicles.

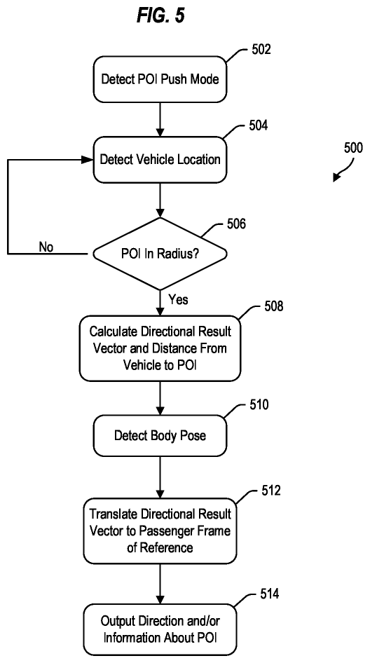

An embodiment of the present technology for implementing an automatic POI push mode will now be described with reference to the flowchart 500 of FIG. 5. In step 502, the onboard computer 112 of an autonomous vehicle may detect a trigger for initiating the automatic POI push mode. This trigger may be any of various physical and/or verbal cues. In further embodiments, an autonomous vehicle may be in the automatic POI push mode by default.

In step 504, the on-board computer 112 of an autonomous vehicle 102 may determine the vehicle's location, and in step 506, may search for POIs within a predefined radius of the vehicle 102. The on-board computer 112 may use a variety of external data sources for locating itself and POIs, such as for example GPS. In combination with GPS, a map of all possible POIs in a geographical area may be stored in the data store 126 of cloud service 120. The on-board computer 112 may periodically query the cloud service 120 for POIs within a predefined radius of a current position of the autonomous vehicle 102. Instead of or in addition to storing POI information on a cloud service, the location and associated information of POIs may be stored in a memory within autonomous vehicle 102. When stored in memory within autonomous vehicle 102, POI' s may be identified without having to contact cloud service 120. The external sensors 302 may also be used to detect POIs within the vicinity of the vehicle 102.

POIs may for example be categorized within storage of cloud service 120 or on-board computer 112. Such categories may include for example historical landmarks, hotels, restaurants, gas stations, etc. The on-board computer 112 can store user preferences, or receive instruction from a passenger, to filter the information received on POIs to one or more particular categories.

Referring again to flowchart 500, the flow may periodically cycle between steps 504 and 506 until a POI within the predefined radius of the autonomous vehicle 102 is identified in step 506. At that point, an identification of the POI, and possibly additional information relating to the POI, may be output to the one or more passengers within the vehicle 102, such as for example visibly on a heads up display in the vehicle 102, and/or audibly on speakers in the vehicle 102. The output information may for example include a name of the POI, address of the POI, directions to the POI, services provided at the POI, a description of the POI, a history of the POI, and a wide variety of other information. Again, this information may be retrieved from memory within the on-board computer 112, or transmitted from cloud service 120. As a non-limiting example, the autonomous vehicle may display or speak, “You are approaching Joe's Restaurant, serving Italian food. Reservations are currently available.” As noted in the above example, the information may be updated in real time, so as to for example include information about current hours of operation, whether reservations are available, etc.

In embodiments, in addition to the information described above, it may be advantageous to describe a location of the POI relative to one or more passengers within an autonomous vehicle 102. For example, in an alternative to the above example, the autonomous vehicle may display or speak “You are approaching Joe's Restaurant on your left, serving Italian food . . . ” Steps for such an embodiment are also shown in flowchart 500 of FIG. 5. In particular, once a POI is identified in step 506, the on-board computer may calculate a vector, referred to herein as a “directional result vector,” in step 508 between the vehicle 102 and the POI.

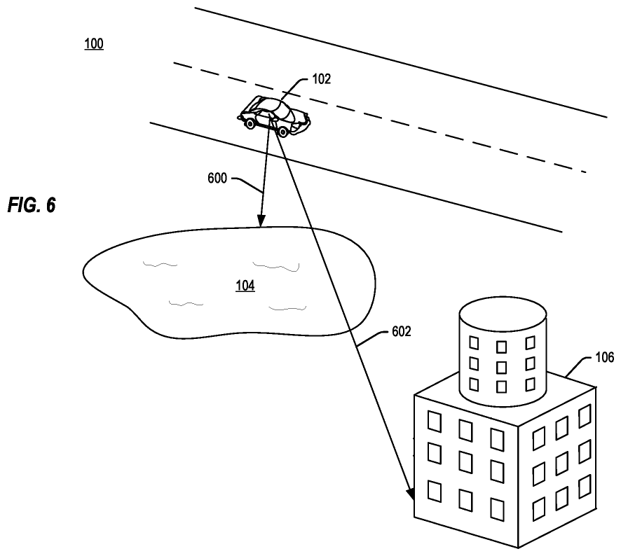

A pair of directional result vectors 600 and 602 are shown in FIG. 6 between an autonomous vehicle 102 and two different POIs 104 and 106. Using the known GPS coordinates of the autonomous vehicle 102 and the known location of the POI 104 or 106 from GPS or cloud data, the on-board computer 112 is able to define a directional result vector between the vehicle and POI. The directional result vector may be expressed in linear or rotational coordinates, and may be two-dimensional or three-dimensional. For example, a difference in height between the position of the vehicle 102 and POI may be ignored so that the directional result vector is two-dimensional. In further embodiments, where height data is available, the directional result vector may be three-dimensional also describing a height difference between the vehicle 102 and POI.

Using the directional result vector, the on-board computer 112 may output the distance and direction of the POI relative to the vehicle 102 in general or specific terms. For example, as noted above, the on-board computer 112 may indicate that a POI is generally “to the left” or “to the right” of the vehicle's current position. Alternatively, the on-board computer 112 may indicate that a POI is at a specific position relative to the vehicle, such as for example “80° North by Northwest” of the vehicle's current position. This specific position is the way of example only and may be expressed in a wide variety of other manners.

In addition to determining a directional result vector between an autonomous vehicle 102 and a POI, the present technology may further specifically determine a directional result vector from the particular perspective of a passenger to the POI. For example, a POI may be “to the left” of a first passenger, but “to the right” of a second passenger facing a different direction than the first passenger within the vehicle 102.

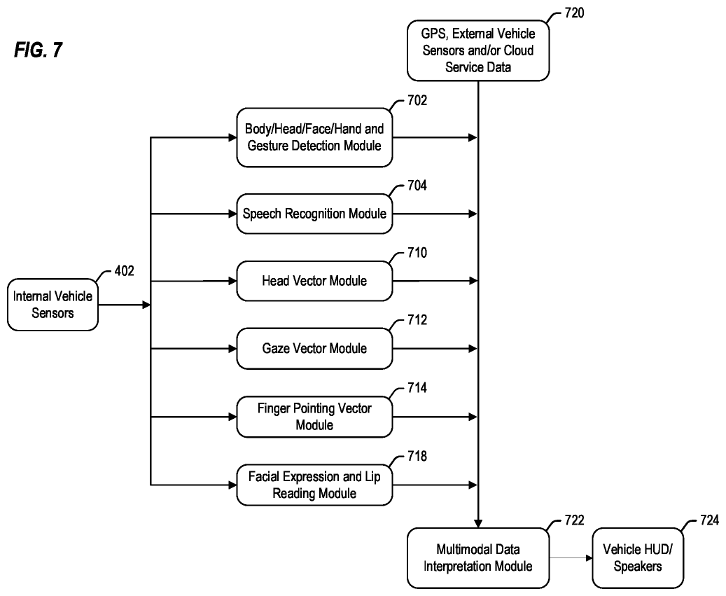

FIG. 5 further includes steps 510 and 512 enabling the on-board computer to translate a directional result vector to the specific frame of reference of a given passenger within the vehicle 102. In particular, in step 510, the one or more interior sensors 402 (FIG. 4) can detect a body pose and orientation of the passenger with respect to the one or more interior sensors 402. Further details for detecting body pose and orientation of a given passenger with respect to the one or more interior sensors 402 are described below with reference to FIGS. 7-10. However, in general, the on-board computer 112 is able to determine and orientation of the passenger's body, head and/or eyes with respect to the one or more interior sensors 402. Using this information, a directional result vector from a POI generally to an autonomous vehicle 102 may be translated to the specific frame of reference of the passenger within the vehicle 102, for example using known special transformation matrices.

Once the position of a POI relative to the vehicle 102 or passenger within the vehicle 102 is determined, direction to the POI and/or information about the POI may be output to the passenger in step 514. As noted, this information may be output visually using a heads up display within the vehicle and/or audibly over a speaker within the vehicle.

As opposed to an automatic POI push mode, the present technology may instead provide POI information in response to requests for such information by one or more passengers within an autonomous vehicle 102. These requests may be made by a person performing actions such as gazing at a POI, pointing at a POI, speaking words related to a POI and/or other physical or verbal cues. Such an embodiment will now be described with reference to FIGS. 7-13.

FIG. 7 is a schematic block diagram of software modules implemented by the on-board computer 112 which receive internal data from the interior sensors 402 to determine when a passenger is requesting information on a POI and where that POI is located. Then, using external data including from exterior sensors 302, the software modules may identify and return information regarding the selected POI. The operation of the software modules shown in FIG. 7 will now be described with reference to the flowchart of FIG. 8.

In step 802, the on-board computer receives multimodal data captured by the interior sensors 402. This multimodal data may include data related to the position of a passenger's body, head, face and/or eyes, as well as data related to speech from the passenger.

In particular, the one or more interior camera and/or image sensors 402 capture image data of a passenger, at a frame rate of, for example, 30 frames per second, and that image data is passed to a body/head/face/hand and gesture detection module 702. The frame rate may vary above or below 30 frames per second in further embodiments. The body/head/face/hand and gesture detection module 702 may execute one or more known algorithms for resolving the data received from the one or more sensors 402 into various data sets representing positions of the passenger's body parts relative to the one or more sensors 402. These data sets may represent the positions of the passenger's body, head, face and/or hands.

For example, the body/head/face/hand and gesture detection module 702 may develop a skeletal model representing positions of the passenger's torso, arms and legs relative to the one or more sensors 402. The body/head/face/hand and gesture detection module 702 may further execute an algorithm for determining the position of the passenger's head relative to the one or more sensors 402. Body/head/face/hand and gesture detection module 702 may further execute a known algorithm for discerning the passenger's face and positions of facial features, including, for example, a position of the passenger's eyes within the head. The body/head/face/hand and gesture detection module 702 may further execute a known algorithm for determining a position of the passenger hands, as well as positions of individual fingers. In embodiments, the body/head/face/hand and gesture detection module 702 may execute the above algorithms as part of a single algorithm or as one or more separate algorithms. In further embodiments, one or more of the above-described algorithms may be omitted.

The above-described body, head, face, eye and/or hand positions may be discerned from a single frame of image data captured from the one or more interior sensors 402. Additionally, as is known, the body/head/face/hand and gesture detection module 702 may look at body, head, face, eye and/or hand movement over time in successive frames of image data to discern movements conforming to predefined gestures. The data describing such predefined gestures may be stored in a gesture library associated with the body/head/face/hand and gesture detection module 702. The body/head/face/hand and gesture detection module 702 may identify a gesture, such as for example pointing, when the received multimodal data conforms to the stored gestural data.

In addition to body, head, face eye, and/or hand position data, the multimodal data may include audio data captured by a microphone of the one or more interior sensors 402. This audio data may be provided to a speech recognition module 704 which can discern speech from the audio data in a known manner. Where there is a single passenger in the vehicle 102, the speech may be attributed that passenger. Where the vehicle has multiple passengers (or audio that is otherwise from multiple sources), other indicators in the multimodal data may be used discern the passenger to whom the speech may be attributed. For example, speech may be attributed to a particular passenger when that speech temporally synchronizes with movements of the passenger's mouth, and/or the shape of the passenger's mouth in pronouncing certain identified phonemes in the speech. Multiple microphones may also be able to discern a speech source through triangulation or other sound localization techniques.

Upon receipt and analysis of the multimodal data in step 802, the on-board computer next looks in step 804 for cues in the data indicative of a request for information relating to a POI around the autonomous vehicle 102. In particular, not all body pose and/or movements of a passenger are interpreted as cues indicative of a request for POI information. Using a set of heuristic rules, the on-board computer analyzes the multimodal data to determine whether the passenger is requesting information relating to a POI.

A wide variety of body, head, face, eye and/or hand positions and movements may be interpreted as a cue requesting POI information. For example, the body/head/face/hand and gesture detection module 702 may determine from head and eye multimodal data that a user is gazing at a fixed position outside of the vehicle. The body/head/face/hand and gesture detection module 702 may additionally or alternatively determine from hand multimodal data that a passenger's hand and fingers are pointing at something outside of the vehicle. The speech recognition module 704 may additionally or alternatively recognize speech related to a POI outside of the vehicle.

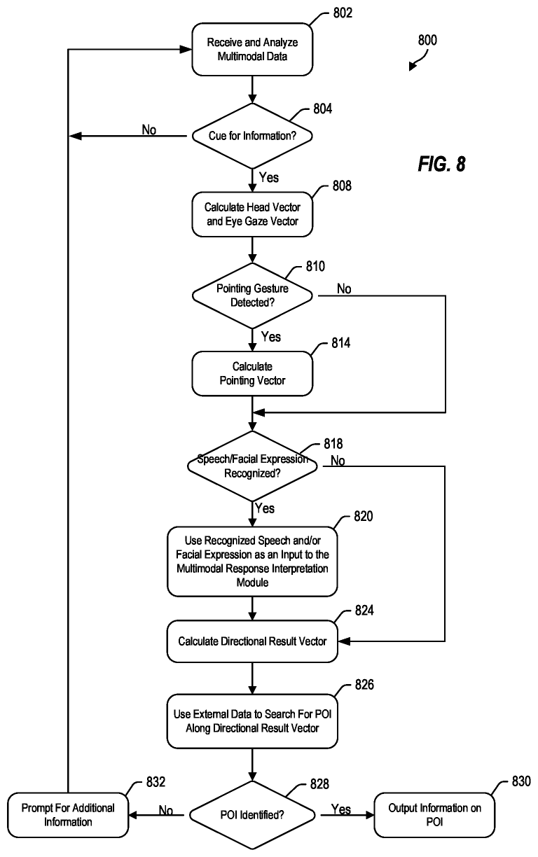

Any one or more of these cues, and a wide variety of others, may be interpreted by the on-board computer as a request for information in step 804. FIG. 9 illustrates an example where the multimodal data indicates a passenger gazing in a fixed direction, performing a pointing gesture and/or speaking words which are recognized as “which building is that?”. Any one or more of these actions may be treated as a cue requesting information regarding a POI within view of the passenger. It is understood that a wide variety of other cues from the multimodal data may be interpreted as a request for information in step 804 in further embodiments.

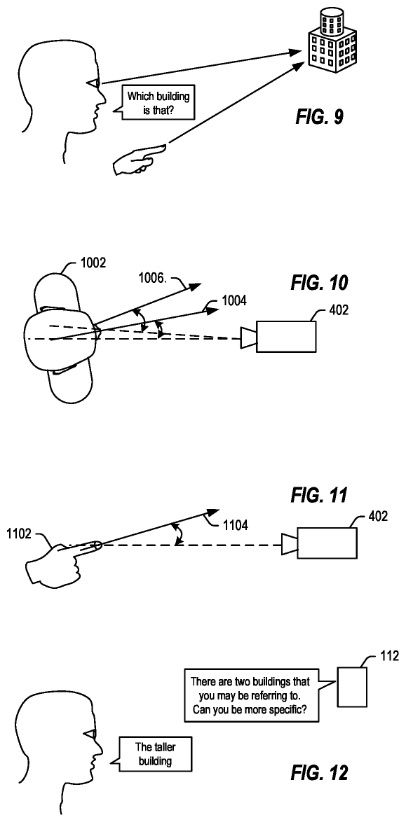

Referring again to the flowchart of FIG. 8, steps 802 and 804 cycle periodically until a physical and/or verbal cue is identified for requesting information about a POI around the vehicle. Once such a cue is identified from the multimodal data, the on-board computer 112 may calculate a head and eye gaze vector in step 808. In particular, the on-board computer may implement a head vector module 710 which calculates a vector in a known manner straight out from a passenger's face, i.e., a vector perpendicular to a plane generally parallel to the passenger's face. An example of a head vector 1004 from a passenger 1002 is shown in FIG. 10. The head vector 1004 may be expressed in terms of linear or rotational coordinates relative to an origin position which may be at a position on the interior sensor 402. The head vector 1004 may, for example, be three-dimensional.

The on-board computer may further implement a gaze vector module 712 which calculates a gaze vector along a line of sight of the passenger's eyes. A wide variety of algorithms are known for calculating a gaze vector. In one example, the algorithm divides a passenger eye into for example 4 quadrants, and then measures the amount of white (i.e., the sclera) in each quadrant. From these measurements, the algorithm may discern where a passenger's eyes are positioned in their head, and the gaze vector may be determined from that position, perpendicularly out from the eye. An example of a gaze vector 1006 from the passenger 1002 is shown in FIG. 10. The gaze vector 1006 may be expressed in terms of linear or rotational coordinates relative to an origin position which may be at a position on the interior sensor 402. The gaze vector 1006 may, for example, be three-dimensional.

In step 810, the on-board computer 112 checks whether the multimodal data showed a passenger performing a pointing gesture. If so, a finger pointing vector module 714 calculates a pointing vector in step 814. The finger-pointing vector module 714 detects the positions of fingers and in particular, a finger which is pointed straight outward while others are curled inward. The module 714 then determines a pointing vector extending in the direction of the pointed finger in a known matter. An example of a pointing vector 1104 from the hand 1102 of a passenger is shown in FIG. 11. The pointing vector 1104 may be expressed in terms of linear or rotational coordinates relative to an origin position which may be at a position on the interior sensor 402. The pointing vector 1104 may for example be three-dimensional.

It is understood that a passenger may point in a wide variety of ways other than with a single extended finger. For example, a passenger may point using an object (e.g. using a pen or pencil in his or her hand). Passengers may also point using body parts other than hands, such as with their elbow, or with their feet, for example in a case where the passenger's hands are disabled or missing. The body/head/face/hand and gesture detection module 702 may be equipped to detect pointing gestures using any of a variety of objects and body parts. Moreover, while referred to herein as a finger pointing vector module, the module 714 may generate a pointing vector out from any of a variety of objects or body parts when a pointing gesture is detected. If no pointing gesture is found in step 810 from the multimodal data, the step 814 of calculating a pointing vector may be skipped.

In step 818, the on-board computer to check whether speech or a facial expression is recognized. In particular, as noted above, the on-board computer may include a speech recognition module 704 capable of recognizing speech in a known manner. If speech is recognized, this is used as an input to a multimodal data interpretation module 722, explained below. Additionally, the on-board computer 112 may implement a facial expression and lip reading module 718. It is conceivable that certain facial expressions may be used as cues indicating a desire for information of a POI outside of the vehicle 102. If such a facial cue is identified, it may be used as input to the multimodal data interpretation module 722. The lip reading module (which may be combined with the facial expression module or separate therefrom) may be used to bolster the recognition of speech by the speech recognition module 704.

If no speech or facial expression is recognized from the multimodal data in step 818, the step 820 of determining the speech and/or facial expression input may be skipped.

In step 824, all of the multimodal data as interpreted by the above-described modules may be input to a multimodal data interpretation module 722 to calculate a directional result vector in step 824. In embodiments, the multimodal data interpretation module 722 may be a neural network receiving as inputs the head vector 1004, the eye gaze vector 1006, the pointing vector 1104, recognized speech and/or a recognized facial expression, process this input through the layers of the neural network, and reach a determination as to a direction of the POI indicated by the passenger. In this instance, the multimodal data interpretation module 722 may output a directional result vector pointing toward the POI as described above with respect to the automatic push mode. The multimodal data interpretation module 722 may further use recognized speech or other cues to discern a particular POI. In embodiments, instead of receiving the physical or verbal cues as described above, the multimodal data interpretation module 722 may receive the raw multimodal data itself.

In embodiments, the multimodal data interpretation module 722 may for example be a convolutional neural network or a recurrent neural network. In this instance, the multimodal data interpretation module 722 may be trained over time using training input data/results and real world data/results (data/results obtained as vehicles travel within driving environment 100 and identify (or misidentify) POIs). In further embodiments, the multimodal data interpretation module 722 may be implemented as an algorithm other than a neural network, as explained below with respect to FIG. 13.

In step 826, the on-board computer uses the output of the multimodal data interpretation module 722, i.e., the directional result vector, to determine the POI referred to by the passenger. In particular, using the directional result vector, the on-board computer may use external data to determine one or more POIs that lie along the directional result vector, within a given vicinity of the vehicle 112. This external data may include GPS data together with POI location information stored in memory of the on-board computer or the data store 126 of cloud service 120. For example, points along the directional result vector may be equated to GPS or geographical coordinates. The on-board computer 112 may determine whether there is a POI at coordinates matching those along the directional result vector. Verbal or other cues may be used to confirm or refute an identified POI. In addition to, or instead of, the GPS and stored POI data, the exterior sensors 302 of the vehicle 102 may be used find one or more POIs that lie along the directional result vector.

In step 828, using the output from the multimodal data interpretation module 722 and the external data, the on-board computer determines whether a POI has been identified satisfying the user's request. If so, the on-board computer causes the information relating to the POI to be output to the one or more passengers within the vehicle 102 in step 830 via an output device, such as, for example, visibly on a heads up display in the vehicle 102, and/or audibly on speakers in the vehicle 102. In particular, the on-board computer sends an instruction to the output device causing the output device to generate an output relaying the information to the one or more passengers. The output information may for example include a name of the POI, address of the POI, directions to the POI, services provided at the POI, a description of the POI, a history of the POI, and a wide variety of other information.

It may happen that the on-board computer is unable to identify a POI in step 828. This may happen because no POI is found, or because multiple POIs are found along the directional result vector, and the multimodal data interpretation module 722 is unable to discern the POI to which the passenger is referring. In this instance, the on-board computer may query the passenger for more information in step 832 and as shown in FIG. 12. The on-board computer may return to step 802 to get new multimodal data and repeat the process, this time also using any additional information received in response to step 832.

The on-board computer may perform the steps in flowchart 800 multiple times per second, such as for example at the sampling rate of the interior sensors 402. In the case where a vehicle is moving and a user is pointing or gazing at a fixed POI, the directional response vector will vary as the passenger's position relative to the POI changes over time. In embodiments, the on-board computer can use multiple directional result vectors, captured over time, to triangulate to a particular POI which satisfies the multiple directional result vectors.

In the embodiments described above, the multimodal data interpretation module 722 may be implemented using a neural network, but it may be implemented using other types of algorithms in further embodiments.

FIG. 13 is a block diagram of a network processing device 1301 that can be used to implement various embodiments of an on-board computer 112 in accordance with the present technology. Specific network processing devices may utilize all of the components shown, or only a subset of the components, and levels of integration may vary from device to device. Furthermore, the network processing device 1301 may contain multiple instances of a component, such as multiple processing units, processors, memories, transmitters, receivers, etc. The network processing device 1301 may be equipped with one or more input/output devices, such as network interfaces, storage interfaces, and the like. The processing unit 1301 may include a central processing unit (CPU) 1310, a memory 1320, a mass storage device 1330, and an input/output (I/O) interface 1360 connected to a bus 1370. The bus 1370 may be one or more of any type of several bus architectures including a memory bus or memory controller, a peripheral bus or the like.

The CPU 1310 may comprise any type of electronic data processor. The memory 1320 may comprise any type of system memory such as static random access memory (SRAM), dynamic random access memory (DRAM), synchronous DRAM (SDRAM), read-only memory (ROM), a combination thereof, or the like. In an embodiment, the memory 1320 may include ROM for use at boot-up, and DRAM for program and data storage for use while executing programs. In embodiments, the memory 1320 is non-transitory. The mass storage device 1330 may comprise any type of storage device configured to store data, programs, and other information and to make the data, programs, and other information accessible via the bus 1370. The mass storage device 1330 may comprise, for example, one or more of a solid state drive, hard disk drive, a magnetic disk drive, an optical disk drive, or the like.

The processing unit 1301 also includes one or more network interfaces 1350, which may comprise wired links, such as an Ethernet cable or the like, and/or wireless links to access nodes or one or more networks 1380. The network interface 1350 allows the processing unit 1301 to communicate with remote units via the networks 1380. For example, the network interface 1350 may provide wireless communication via one or more transmitters/transmit antennas and one or more receivers/receive antennas. In an embodiment, the processing unit 1301 is coupled to a local-area network or a wide-area network for data processing and communications with remote devices, such as other processing units, the Internet, remote storage facilities, or the like.

It is understood that the present subject matter may be embodied in many different forms and should not be construed as being limited to the embodiments set forth herein. Rather, these embodiments are provided so that this subject matter will be thorough and complete and will fully convey the disclosure to those skilled in the art. Indeed, the subject matter is intended to cover alternatives, modifications and equivalents of these embodiments, which are included within the scope and spirit of the subject matter as defined by the appended claims. Furthermore, in the following detailed description of the present subject matter, numerous specific details are set forth in order to provide a thorough understanding of the present subject matter. However, it will be clear to those of ordinary skill in the art that the present subject matter may be practiced without such specific details.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

The computer-readable non-transitory media includes all types of computer readable media, including magnetic storage media, optical storage media, and solid state storage media and specifically excludes signals. It should be understood that the software can be installed in, and sold with, the device. Alternatively, the software can be obtained and loaded into the device, including obtaining the software via a disc medium or from any manner of network or distribution system, including, for example, from a server owned by the software creator or from a server not owned but used by the software creator. The software can be stored on a server for distribution over the Internet, for example.

Computer-readable storage media (medium) exclude (excludes) propagated signals per se, can be accessed by a computer and/or processor(s), and include volatile and non-volatile internal and/or external media that is removable and/or non-removable. For the computer, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

For purposes of this document, each process associated with the disclosed technology may be performed continuously and by one or more computing devices. Each step in a process may be performed by the same or different computing devices as those used in other steps, and each step need not necessarily be performed by a single computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A system for identifying a point of interest around an autonomous vehicle, comprising:
a set of one or more sensors within the autonomous vehicle for sensing data related to one or more of a group consisting of body pose, eye gaze, a pointing gesture or speech by a passenger in the autonomous vehicle;
an output device within the autonomous vehicle; and
a computer within the autonomous vehicle, the computer executing instructions to:
receive the data sensed by the set of one or more sensors;
determine a direction from the data received;
determine the point of interest lying along the direction determined; and
send an instruction to the output device to output information related to the point of interest determined, the output device outputting the information as a result of receiving the instruction sent from the computer.

2. The system of claim 1, wherein the data received from the set of one or more sensors relates to a position of the passenger's head and eyes.

3. The system of claim 1, wherein the data received from the set of one or more sensors relates to the pointing gesture performed by the passenger.

4. The system of claim 1, wherein the data received from the set of one or more sensors relates to recognized speech describing a direction at which the point of interest is located.

5. The system of claim 1, wherein the computer determines the point of interest from the direction determined, and received data relating to stored locations of points of interest around the autonomous vehicle.

6. The system of claim 5, wherein the received data relating to stored locations around the autonomous vehicle comprises at least one of global positioning system (GPS) data, data sensed by a second set of one or more sensors on the autonomous vehicle and data received from a cloud service.

7. A system for identifying a point of interest around an autonomous vehicle, comprising:
a set of one or more sensors within the autonomous vehicle for sensing data related to at least one of body pose, eye gaze, a pointing gesture and speech by a passenger in the autonomous vehicle;
an output device within the autonomous vehicle; and
a computer within the autonomous vehicle, the computer executing instructions to:
infer a directional result vector from the data sensed by the set of one or more sensors,
identify the point of interest around the autonomous vehicle which lies along the directional result vector, and
send an instruction to the output device to output the point of interest identified, the output device outputting the point of interest as a result of receiving the instruction sent from the computer.

8. The system of claim 7, wherein the computer further recognizes the speech from the passenger, the computer using the speech to assist in identifying the point of interest.

9. The system of claim 7, wherein the computer further receives external information in order to identify the point of interest which lies along the directional result vector.

10. The system of claim 7, further comprising a body and gesture detection module implemented by the computer, the body and gesture detection module detecting a skeletal model of the passenger at at least one instant in time.

11. The system of claim 10, further comprising a head vector module implemented by the computer for determining a head vector from the skeletal model, the head vector indicating a direction the passenger's head is facing.

12. The system of claim 7, further comprising an eye gaze vector module implemented by the computer for determining an eye gaze vector indicating a direction the passenger's eyes are looking.

13. The system of claim 10, further comprising a finger pointing vector module implemented by the computer for determining a finger pointing vector from the skeletal model, the finger pointing vector indicating a direction along which the passenger is pointing.

14. The system of claim 7, further comprising a speech recognition module implemented by the computer for recognizing speech related to an identity of the point of interest.

15. The system of claim 11, further comprising a multimodal response interpretation module for receiving at least one of the head vector, eye gaze vector, finger pointing vector and recognized speech, and inferring the directional result vector from the received at least one of the head vector, the eye gaze vector, the finger pointing vector and the recognized speech.

16. The system of claim 15, wherein the multimodal response interpretation module is implemented using a neural network.

17. A method of identifying a point of interest around an autonomous vehicle, comprising:
receiving an indication of a direction from data obtained from a passenger of the autonomous vehicle, wherein the data relates to at least one of body pose and speech recognition;
determining the point of interest lying in the direction of the indication of direction received;
outputting the point of interest to an output device within the autonomous vehicle.

18. The method of claim 17, said step of receiving an indication of a direction at which the point of interest is located comprises the step of receiving data relating to a position of the passenger's head and eyes.

19. The method of claim 17, said step of receiving an indication of a direction at which the point of interest is located comprises the step of receiving and recognizing a pointing gesture performed by the passenger.

20. The method of claim 17, said step of receiving an indication of a direction at which the point of interest is located comprises the step of receiving and recognizing speech from the passenger describing a direction at which the point of interest is located.

21. The method of claim 17, said step of determining the point of interest lying in the direction of the indication of direction received comprises the step of received data relating to stored points of interest around the autonomous vehicle.

22. A non-transitory computer-readable medium storing computer instructions that when executed by one or more processors cause the one or more processors to perform the steps of:
receiving an indication of a direction at which a point of interest is located from data received from a passenger of an autonomous vehicle related to at least one of body pose and speech recognition;
determining the point of interest lying in the direction of the indication of direction received;
outputting information related to the point of interest to an output device within the autonomous vehicle.
